(19) United States
(12) Patent Application Publication
(10) Pub. No.: US 2012/0281437 A1
(43) Pub. Date: Nov. 8, 2012

(54) DIGITAL IC CONTROLLER FOR SWITCH MODE POWER SUPPLY DEVICES

(75) Inventors: Martin Fritz, Tuebingen (DE); Heiko Schall, Nuertingen (DE)

(73) Assignee: ERBE ELEKTROMEDIZIN GMBH, Tuebingen (DE)

(21) Appl. No.: 13/522,643

(22) PCT Filed: Dec. 10, 2010
(86) PCT No.: PCT/EP2010/069326

§ 371 Date: Jul. 17, 2012

(30) Foreign Application Priority Data
Jan. 18, 2010 (DE) 102010000098.1
Mar. 11, 2010 (DE) 102010015926.3

(51) Int. Cl. H02M 3/335

(52) U.S. Cl. 363/21.09

(57) ABSTRACT

A digital IC controller for switch mode power supplies, the IC controller having multiple inputs and multiple outputs as well as a digital interface. The IC controller can be configured using a configuration device in such a way that controller units and filter units preconfigured by the configuration device as well as other functions are selected and parameterized and are transferred to the IC controller using the digital interface.

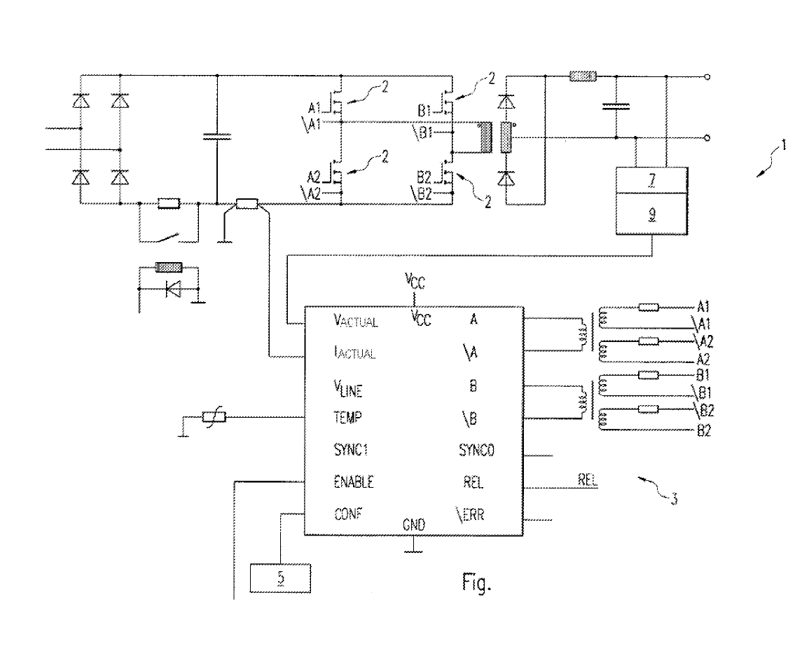

The invention relates to a digital IC controller according to the preamble of claim 1.

IC controllers of the type discussed here are generally known. Switch mode power supply devices, also called switch mode power supplies, such as, for example, flyback converters, forward converters or step-up controllers and step-down controllers, require such an IC controller for driving power semiconductors such as FETs or IGBTs. Since the IC controller usually controls the gate voltage of the power semiconductors, it is also referred to as a “gate driver”. Power factor correctors (PFC), too, normally require an IC controller. Furthermore, the current and voltage profile of the power supply device is intended to be controlled by an IC controller of the type discussed here.

IC controllers of the type described above are sufficiently known from analog technology. However, analog controllers of this type have some disadvantages. In particular, variation as a result of component tolerances occurs therein. As a result, there is the risk of a controller configured by analog components becoming unstable. Furthermore, analog controllers of this type are particularly complex in terms of circuitry. In particular, depending on the application, 10 to 30 additional components have to be provided, which, of course, also have to be dimensioned. Furthermore, functionalities such as limiting the output voltage on account of a power or temperature limitation, so-called “derating”, can be realized only with great difficulty. Realizing a power factor corrector (PFC=Power Factor Corrector) necessitates a multiplier for example. Moreover, the multiplier has circuitry inadequacies that have to be taken into account by the external circuit interconnection.

Furthermore, a change in the filter or controller constants during the product life time often means changing the layout of the circuit board, which should be avoided.

Therefore, it is an object of the present invention to provide an IC controller for switch mode power supply devices which is constructed in a simple manner and which permits fast access to a switch mode power supply device.

A digital IC controller comprising the features of claim 1 is proposed for achieving this object.

The digital IC controller for switch mode power supplies according to the invention comprises a plurality of inputs and a plurality of outputs and also a digital interface. The IC controller can be configured by means of a configuration device in such a way that controller and filter units preconfigured by means of the configuration device and further functions are selected and parameterized and are transferred to the IC controller by means of the digital interface, the configurations preferably being permanently stored at said IC controller.

Preferably, the digital IC controller has the following input interfaces:
actual voltage (V_{ACTUAL});
actual current (I_{ACTUAL});
power supply system voltage (V_{LINE});
temperature (TEMP);
synchronization interface for the transistor switching edges (SYNC_IN, SYNC_OUT);
operation enable interface (ENABLE), and
configuration interface (CONF).

Furthermore, the digital IC controller preferably has at least the following output interfaces:
gate signals of the power semiconductors (A, \A, B, \B);
error/status message (\ERR), and
setpoint current (ISETP).

The digital IC controller for switch mode power supply devices that is proposed here, in contrast to an analog embodiment of an IC controller of this type, advantageously makes it possible to configure the IC controller by means of an external configuration device. Therefore, it does not have to be programmed. The limited number of input interfaces and output interfaces furthermore affords a particularly simple design of the IC controller. Preferably, the IC controller operates in current mode operation. Furthermore, it is preferably provided that the configuration device is stored as a computer program on a PC and, in this way, permits simple access by a developer to a graphical user interface by means of which the parameters can be changed in a simple manner. The IC controller is therefore preferably not programmed, but rather exclusively configurable, such that a developer need not perform programming of the IC. Simple operation of the configuration device suffices to make changes to the IC controller, in particular to select and to parameterize preconfigured controller and filter units and further functions. Preferably, the IC controller serves for driving a switch mode power supply device. Configuration settings performed by a developer by means of the configuration device are, as stated, transferred via a digital interface to the IC controller and preferably permanently stored there. A multiplicity of configurations of the IC controller can be performed by means of the configuration device. Possible parameters to be set are, in particular:
circuit type;
switching frequency or bandwidth;
PWM modulation limit;
filter time constant;
controller configuration, in particular time constant;
setpoint and maximum values for current and voltage;
turn-off values;
soft start configuration;
power and temperature limiting (derating);
configuration of additional outputs;
configuration of supply voltage monitoring;
configuration of a blanking mode.

The invention is explained in greater detail below with reference to the single drawing.

The FIGURE shows a schematic illustration of a purely exemplary power supply device 1. The function of power supply devices of this type is sufficiently known and will therefore not be explained in greater detail in the present case. What is crucial is that, for driving switching elements 2, in particular power semiconductors, which are embodied here as MOSFETS, driving has to be effected by means of a suitable IC controller 3. For this purpose, the outputs A1, B1, A2, B2 of the IC controller 3 are connected to the inputs of the gate terminals of the power semiconductors or (MOS)FETs of the power supply device 1.

The IC controller 3 is a digital IC controller which can be configured by means of a configuration device 5. Therefore, unlike the customary case, the IC controller 3 is not programmed by means of a programming language, rather changes that are desired depending on the application can be performed simply by means of the configuration device 5. This can be realized by a user for example by means of a graphical user interface (GUI). In this case, the configuration device 5 is preferably embodied as a computer program and stored on a storage medium of a computer. By means of the configuration device 5, preconfigured controller and filter units and further functions can be selected and parameterized.

The IC controller 3 preferably operates in the current mode. By means of the four switching elements 2 or A1, B1, A2, B2, which are embodied here by way of example as FETs, a switch mode power supply device is provided. It goes without saying that provision can also be made for the power supply device 1 to have only one or two or else more than four power semiconductors 2. In principle, the IC controller 3 according to the invention can interact with virtually as many switching elements as desired.

The clocking of the switching elements 2 is controlled by means of the IC controller 3. In this way, it is possible to regulate the current and voltage profiles in the power supply device. The configuration settings performed by means of the configuration device 5 are preferably transferred to the IC controller via a digital interface, such as, for example, SDI (Serial Peripheral Interface) or JTAG (Joint Test Action Group) or the like. The configuration settings are then preferably permanently stored in the IC controller 3.

In contrast to a microcontroller, the IC controller according to the invention is therefore not programmed, rather only preconfigured controller and filter units and further functionalities are selected and parameterized and subsequently transferred to the IC controller.

The configuration can contain, for example, the selection of the circuit type. The latter can be, for example, a step-up controller, step-down controller, flyback converter, PFC, SEPIC or a forward converter. Depending on what converter type was selected, the appropriate configuration of the inputs and outputs of the IC controller 3 can then be performed automatically by means of the configuration device 5. The IC controller 3 according to the invention can therefore interact with any desired power supply device.

Furthermore, a phase-shift driving, i.e. a phase-offset driving of parallel inductive branches, particularly when driving step-up controller, step-down controller and PFC, can be provided. The configuration of the switching frequency or of the bandwidth of a spread spectrum possibly desired is also conceivable. Furthermore, the PWM modulation limit DMIN, DMAX can be selected and a dead time can be provided between an upper and a lower switching element 2.

The selection and the setting of filter time constants or else the possibility of connecting in median filters for analog signals are furthermore conceivable. Furthermore, configurations of the controller 7 can be performed, which controller can be, for example, a P, PI or PID controller. The controller can possibly have a low-pass filter behaviour. If a potential isolation 9 is provided, as is illustrated in the FIGURE, a time constant bridging of the voltage controller 7 for start-up or for external control can additionally be provided. Furthermore, configurations of the setpoint and maximum values of current and voltages and turn-off values, particularly in the case of overvoltage and overcurrent, can be performed. Furthermore, a soft start configuration can be effected or a line and temperature limiting can be provided. Moreover, the setting up of additional outputs for example for status messages or a relay output for bridging an inrush current limiter is conceivable. Furthermore, configurations of a supply voltage monitoring, in particular also a monitoring of the switch-on and switch-off hysteresis, are conceivable. Configurations of a blanking mode can also be performed in the IC controller, such that a sampling of analog values at the switching instant of the transistors is suppressed.

The FIGURE makes it clear that the IC controller 3 has inputs for the following parameters: controlled variable actual voltage: V_{ACTUAL}; subordinate controlled variable actual current: I_{ACTUAL}; power supply system voltage for PFC: V_{LINE}; temperature: TEMP; the synchronization of the transistor switching edges: SYNC_IN and SYNC_OUT; operation enable: ENABLE, and an input for the configuration interface: CONF, which can also be embodied in multiwired fashion.

Furthermore, the IC controller has outputs for the following parameters: gate signals having increased driver power for the switching elements 7, which are usually ˜2 amperes: A, \A, B, \B; for the 2-phase variant of the switching elements, additional outputs can be provided: C, \C; a relay output for bridging an inrush current limiter: REL, and error or status message output: \ERR. The output for error or status messages can be embodied in multiwired fashion. It is also conceivable to embody the output as a bus, which can be, for example, of one of the following types: I²C, CAN. Finally, an output is also provided for a setpoint current predefinition ISETP, which is preferably effected in analog fashion and serves for controller development.

Overall, it is evident that the present invention advantageously discloses a digital IC controller which can be produced particularly simply and cost-effectively and permits a configuration of the IC controller without necessitating programming activity on the part of the developer. A simple construction of the IC controller is furthermore ensured by the limited number of inputs and outputs. By means of the inputs and outputs described above, any desired switch mode power supply device can be driven by means of the IC controller according to the invention. Furthermore, numerous configuration settings can be performed on the IC controller.

### LIST OF REFERENCE SIGNS

1 Power supply device
2 Switching element
3 IC controller
5 Configuration device
7 Controller
9 Potential isolation

1. A digital IC controller for switch mode power supplies, comprising a plurality of inputs and comprising a plurality of outputs and also comprising a digital interface, wherein the IC controller can be configured by means of a configuration device in such a way that controller and filter units preconfigured by means of the configuration device and further functions are selected and parameterized and are transferred to the IC controller by means of the digital interface.

2. The digital IC controller as claimed in claim 1, wherein the configurations are permanently stored in the IC controller.

3. The digital IC controller as claimed in claim 1, wherein it has the following input interfaces:
actual voltage (V_{ACTUAL});
actual current (I_{ACTUAL});
power supply system voltage (V_{LINE});
temperature (TEMP);
synchronization interface for the transistor switching edges (SYNC_IN, SYNC_OUT);
operation enable interface (ENABLE);
configuration interface (CONF),

4. The digital IC controller as claimed in claim 1, wherein it has the following output interfaces:
gate signals of the power semiconductors (A, \A, B, \B);
error/status message (\ERR), and
setpoint current (ISETP).

5. The digital IC controller as claimed in claim 1, wherein it is operated in the “current mode”.

6. The digital IC controller as claimed in claim 1, wherein the configuration device is stored as a computer program on a PC.

7. The digital IC controller as claimed in claim 1, wherein it is exclusively configurable.

8. The digital IC controller as claimed in claim 1, wherein it serves for driving a switch mode power supply device.

9. The digital IC controller as claimed in claim 1, wherein the configuration device allows a configuration of at least one of the following parameters:
circuit type;
switching frequency or bandwidth;
PWM modulation limit;
filter time constant;
controller configuration, in particular time constant;
setpoint and maximum values for current and voltage;
turn-off values;
soft start configuration;
power and temperature derating;
configuration of additional outputs;
configuration of supply voltage monitoring;
configuration of a blanking mode.
